(19) United States
(12) Patent Application Publication
(10) Pub. No.: US 2009/0153928 A1
(43) Pub. Date: Jun. 18, 2009

(54) ENGINE FOR VIDEO PROJECTION/DIGITISER/DIGITAL RADAR WITH MULTIPLE ELECTROMAGNETIC RADIATION BEAMS

(76) Inventor: Jean-Marc Desaulniers, Binic (FR)

Correspondence Address: JEROME D. JACKSON (JACKSON PATENT LAW OFFICE), 211 N. UNION STREET, SUITE 100, ALEXANDRIA, VA, 22314, US

(21) Appl. No.: 12/279,576

(22) PCT Filed: Feb. 15, 2007
(86) PCT No.: PCT/FR07/00273

§ 371 Date: Jan. 30, 2009

(30) Foreign Application Priority Data
Feb. 16, 2006 (FR) 0601364

(51) Int. Cl. G02B 26/10

(52) U.S. Cl. 359/17

(57) ABSTRACT

Engine for video projection/digitiser/digital radar with multiple electromagnetic radiation beams for carrying out the projection or recording in 2D or 3D on any surface or in any volume. The invention relates to an optical digital video projection device for multi beam projection onto any surface or into any volume in 2D or 3D, within a solid angle from 0° to 360°, for example, 180, 270, or 360°. The device can also be used in digitiser and/or radar function for the recording/digitisation of spatial and frequency information. The processing of electromagnetic radiation, for example, visible, infrared ultraviolet, microwave radiation in lime, space and frequency either passively or actively for example, by means of mirror/filter windows permits a filter function specific to the target applications. The source uses a light source comprising, for example, a number of weak/medium/high power lasers coupled to a number of optical sources, optical source modules, coloured beam generators or optical matrix heads. The digitisation function uses, for example, a number of photodiode capture devices, charge coupled devices (CCD), etc. The function for digitisation/optical radar in 2D or 3D using light beams permits use in different types of application, in telecommunications, for road maritime, aerial or space navigation.

The current invention relates to a device performing the electromagnetic multibeam digital video projection, for example, visible, infrared, ultraviolet or microwave optics, onto any 2D or 3D surface or into any volume, within a solid angle from 0 to 360°, for example 180°, 270° or 360°, using as a light source a number of weak/medium/high power lasers. Insertion of a set of sensors coupled with sources permits using of the device as 2D or 3D digitiser and/or radar, within a solid angle from 0 to 360°, for example 180°, 270° or 360°. Fields of use of the invention can be: the digital video projection onto a surface or into a volume, telecommunications for road, seaborne, air or space navigation.

Displays on 360° screens are often carried out by a variation of multi-screen assembling. A ribbon of screens winds itself around a circular room to offer the customer a 360° vision of a landscape, an event. Another display application, which can be used in a planetarium, is implementation of a number of classic video projectors, for example, DLP, LCD, GLV or CRT type, airing the show onto a dome.

Display in a 3D dome can be performed as IMAX Solido® principle process where pictures are projected onto a hemispheric screen, for example with “fish-eye” lens. The depth perception is restored by liquid crystal glasses. Display alternates two images: one for each eye. Each glass becomes alternately opaque according to an order from the projector, allowing each eye to receive only the intended picture.

Several approaches are also being developed for the conception of scanning-based projector systems. For example, one of them is based on a projector system coupled with a deflection mirror. The deflection mirror, moving over two axes, allows screen scanning, for example hemispheric. The video frame is then cut off by a digital processing into a combination of a certain number of images parts scanned onto the screen at a sufficient rate for the human eye and gives it the impression of a single image. This process, which is often used to create a projection system based on laser beams, for example red, green and blue, allows to create a sequence of animated coloured images by means of a modulation by image information and a quick beams deflection.

Another approach is to use a certain number of beams of various sizes as a very large, a medium and a thin. A digital image processing, especially in terms of colours, can modulate each of these beams which are deflected by actuators in order to scan the screen, creating the picture by light spots overlapping.

Most of these equipments are affected, in the case of common video projection, with the low resolution and/or the high cost technology carries out during the film shooting or the documentary or the motion picture display. Installations including several projectors to cover the screen have problems in pictures overlapping areas, and in the respect of colour uniformity on the projection surface or volume, because of the use of several different equipments. Laser-based projectors are, most of the time, lacking of pictures spatial stabilization and/or have a too low resolution when it comes to display pictures with the same quality as film-based projector.

The device under patent enables reproduction and/or recording of a sequence of coloured pictures, thanks to a certain number of light sources, onto any surface or into any volume. The aim is to preserve intrinsic specifications of the original signal at the output of the device (gamut, mixing, colour temperature, resolution/definition, contrast level) on any surface or any volume.

The video projection/digitisation/radar detection, performed by an almost entirely optical device, dealing with electromagnetic beams, for example visible, infrared, ultraviolet, microwave, and incorporating mirrors/filters, is thus optimized since it does involve only a series of reflections/transmissions on optical rotating discs, which at the end will experience very limited mechanical wearing. The operating principle includes multibeam scanning of the surface or volume, used as a screen, through successive reflexions/transmissions of a certain number of beams coming from, for example a certain number of light sources as weak/medium/high power lasers, coupled with a certain number of optical sources, optical sources modules, coloured pixel generators or optical matrix heads. The scan function uses, for example, a certain number of photodiode capture devices, Charge-Coupled Device (CCD), etc. Optical rotating discs, in the device, allow generation of a scanning in the space. An addressing periscope allows to structure a certain number of beams onto any surface or into any volume.

According to specific configuration modes, it is possible to add a stand structure of mirrors/filters windows to the device that enabling, for example, a spatial/frequency/temporal multiplexing complementary to the source beams.

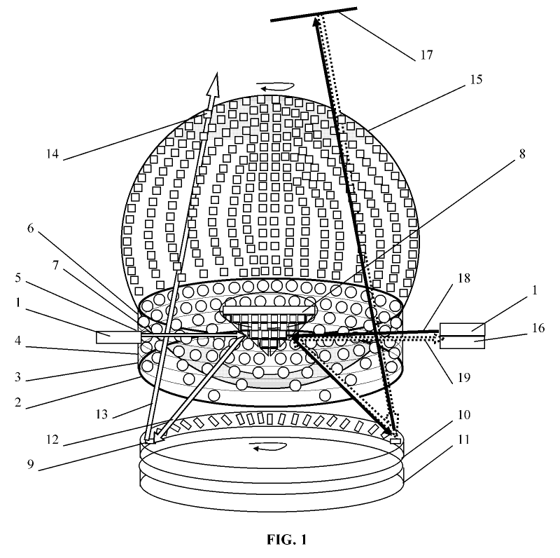

FIG. 1 illustrates, in perspective view, a simplified pattern of the multibeam scanning digital video projection device structure enabling projection onto any surface or into any volume, and/or the 2D or 3D recording/digitisation, within a solid angle from 0 to 360°, for example 180°, 270° or 360°.

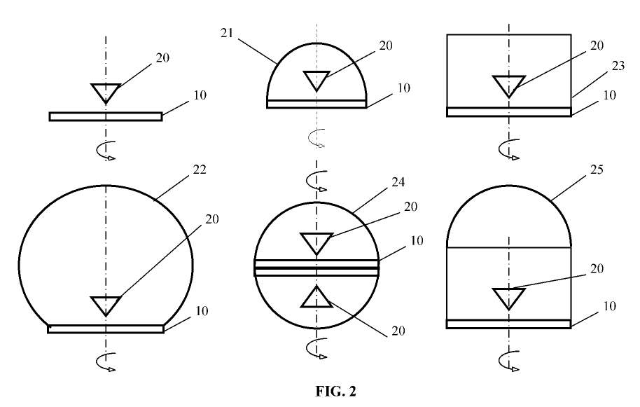

FIG. 2 illustrates, in sectional view, a schematic view of different architectures of the optical multibeam scanning digital video projection device structure.

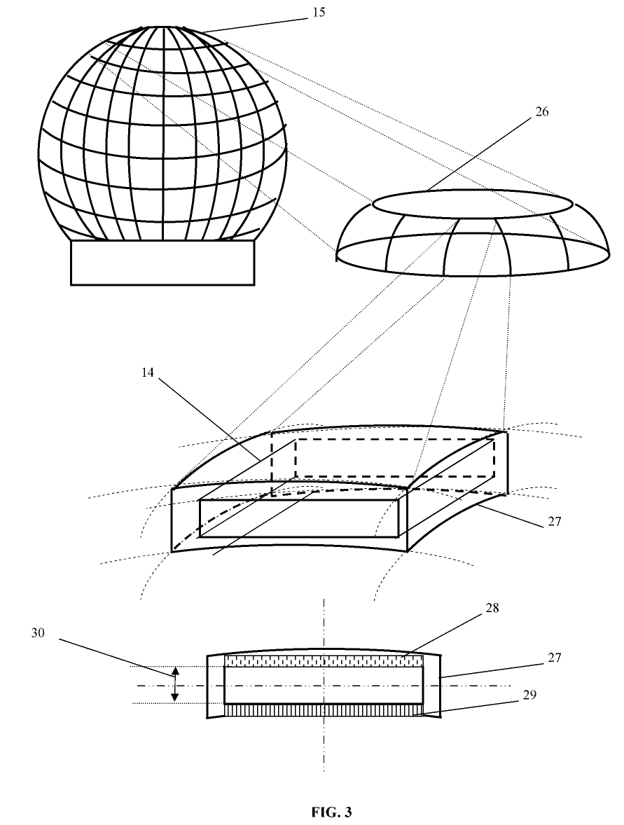

FIG. 3 illustrates, in perspective view, a stand of mirrors/filters windows, for example dome-shaped, and a fragmented view to detail the positioning of mirrors/filters windows.

FIG. 4 illustrates, in perspective view, different scanning possibilities of a mirror/filter which is part of the multibeam scanning digital video projection device.

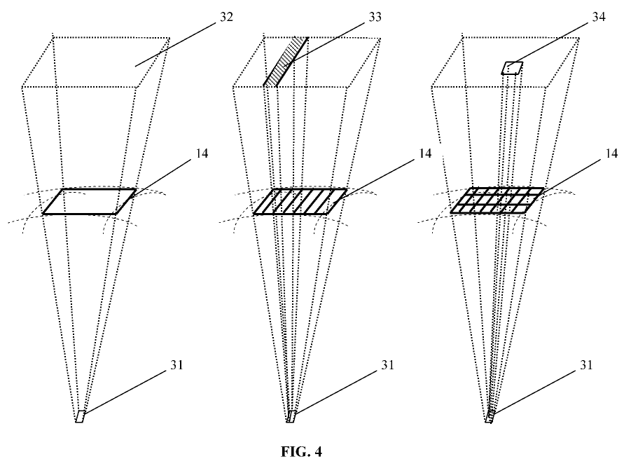

FIG. 5 illustrates, in perspective view, an addressing periscope for a multibeam scanning video projection and/or digital recording device composed of a deviation cone.

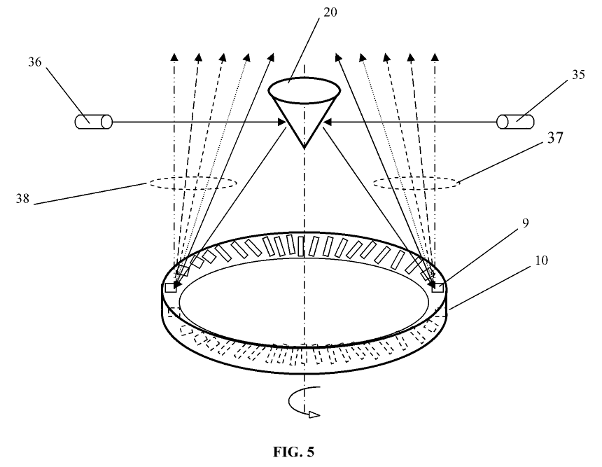

FIG. 6 illustrates, in perspective view, an addressing periscope for a multibeam scanning video projection and/or digital recording device composed, for example, of two deviation cones face-to-face.

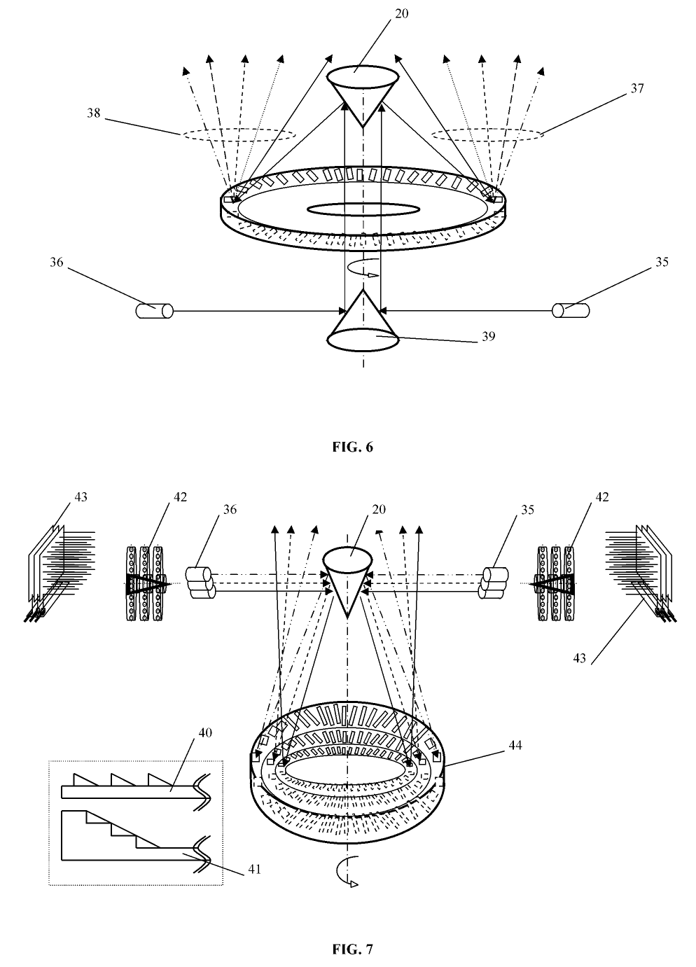

FIG. 7 illustrates, in perspective view, an addressing periscope for a multibeam scanning video projection and/or digital recording device addressing, for example, a multi-sector disc with a certain number of optical sources modules and/or optical matrix heads, for example crown/pyramid type or pavements of mirrors/filters.

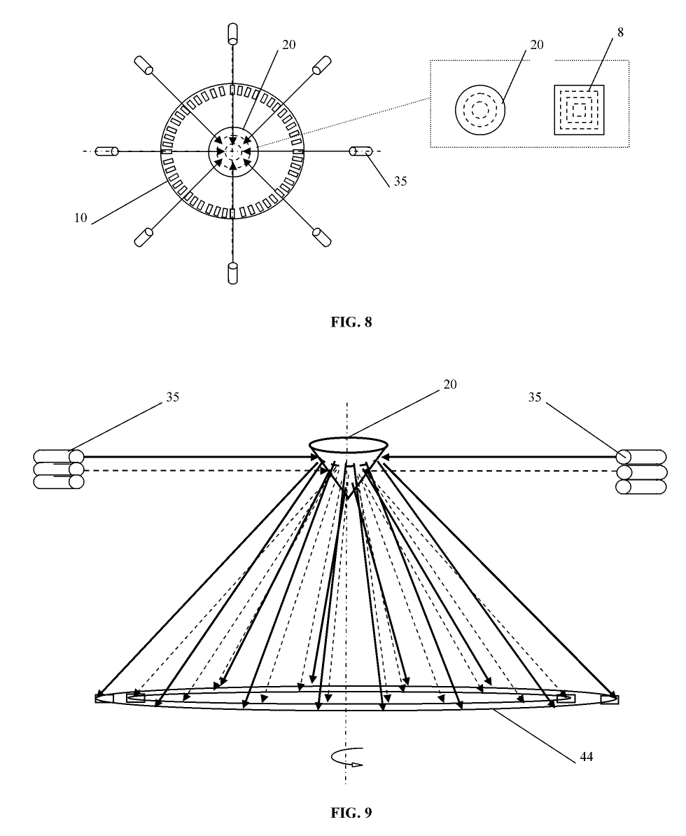

FIG. 8 illustrates, in upper view, an addressing periscope, composed of a cone or a pyramid, for a multibeam scanning video projection and/or digital recording device addressing a multi-sector disc with a certain number of optical sources modules and/or optical matrix heads, for example crown/pyramid type or pavements of mirrors/filters.

FIG. 9 illustrates, in perspective view, an addressing periscope for a multibeam scanning video projection and/or digital recording device addressing a multi-sector disc with a number of optical sources modules and/or optical matrix heads, for example crown/pyramid type or pavements of mirrors/filters, spread over a certain number of levels enabling simultaneous addressing of a certain number of mirrors/filters spread over a certain number of sectors.

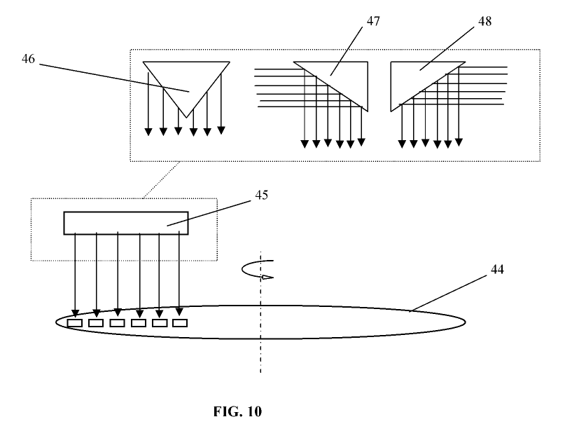

FIG. 10 illustrates, in sectional view, a simplified view of an optical multi-sector rotating disc and a certain number of addressing periscopes.

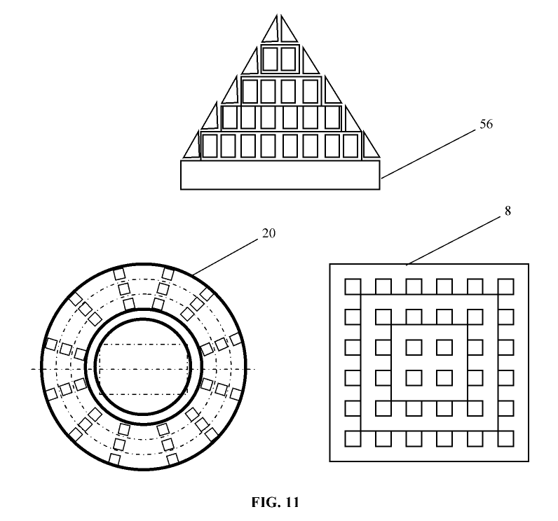

FIG. 11 illustrates, in upper and side view, a pyramid and an addressing periscope deflecting cone for a multibeam scanning video projection and/or digital recording device.

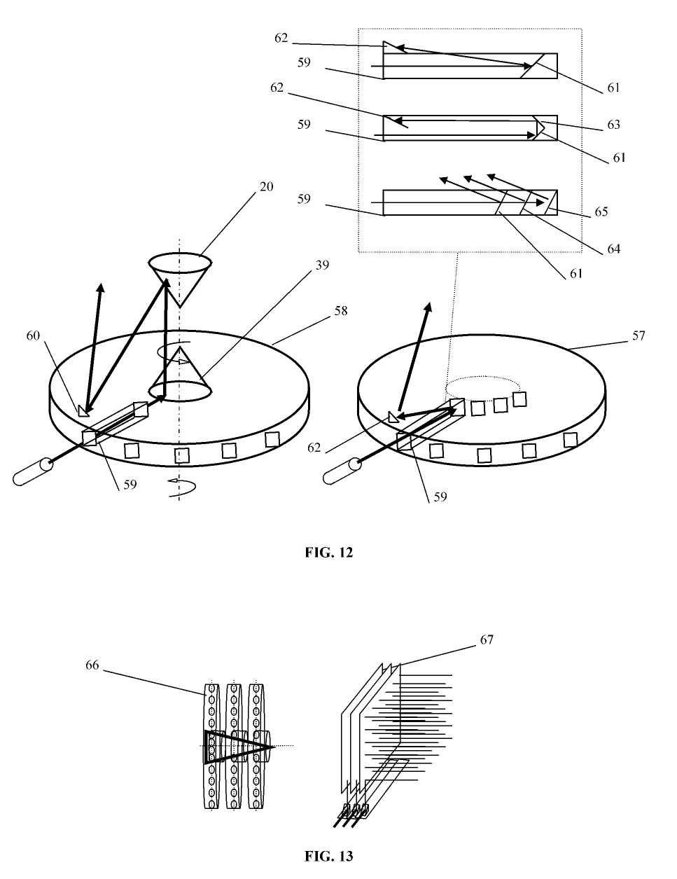

FIG. 12 illustrates, in perspective view, two optical rotating discs alternatives with an on-board addressing periscope and an optical lane enabling slice addressing.

FIG. 13 illustrates, in sectional view, optical matrix heads alternatives of crown/pyramid type or pavements of mirrors/filters.

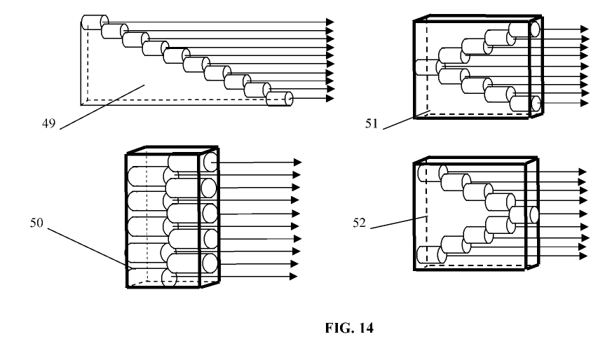

FIG. 14 illustrates, in perspective view, optical sources modules and/or coloured pixel generators alternatives enabling, simultaneous or not, addressing of several sectors and/or mirrors/filters of an optical rotating disc by means of an addressing periscope or not.

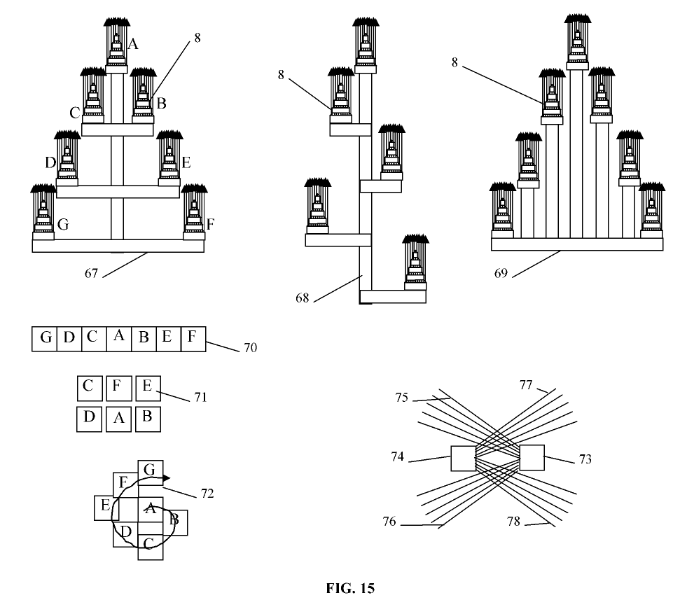

FIG. 15 illustrates, in sectional view, a simplified view of several possible layouts of pyramids and/or cone for addressing periscope and/or optical matrix head.

FIG. 16 illustrates, in upper view, the first level of an optical matrix head of a light-beam digital video projection motor composed of a pyramidal device with reflecting facets, rings and optical sources modules.

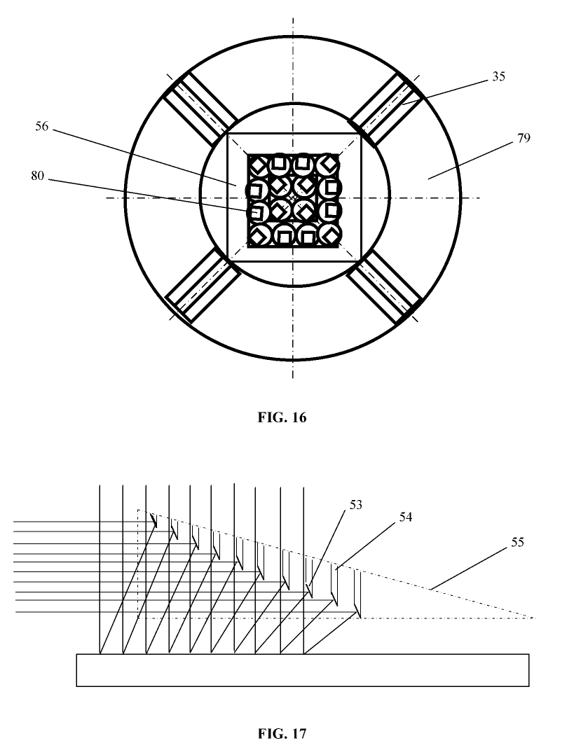

FIG. 17 illustrates, in sectional view, an alternative mirrors/filters organization of an addressing periscope for multibeam scanning video projection and/or digital recording device.

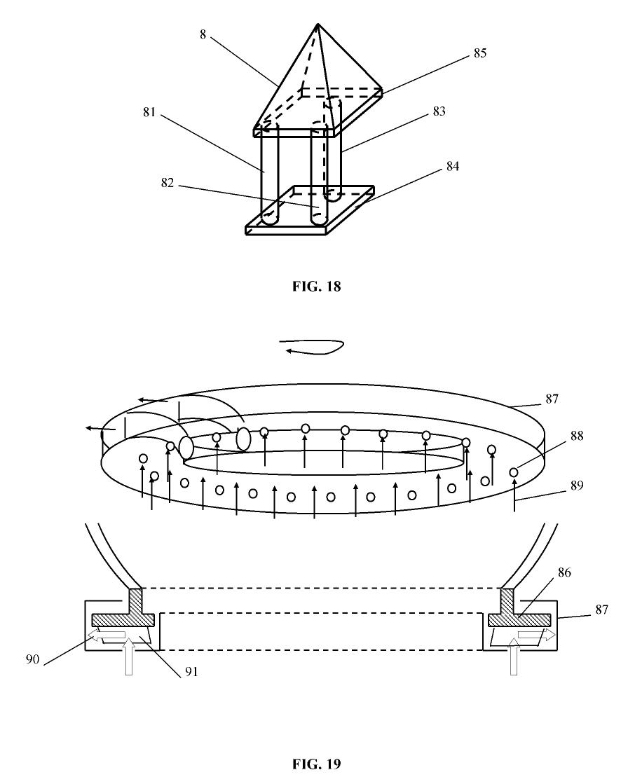

FIG. 18 illustrates, in perspective view, a stable position adjustment device composed, for example, of screws, micro-actuator, piezoelectric . . . which could be adapted on various elements of a multibeam scanning video projection and/or digital recording equipment.

FIG. 19 illustrates, in perspective and sectional view, a rotating and lift stage on air cushion for multibeam scanning video projection and/or digital recording device.

As a reference to the drawings, the optical multibeam scanning digital video projection device (FIG. 1), enabling projection onto any surface or into any volume, and/or the 2D or 3D recording/digitisation, within a solid angle from 0 to 360°, for example 180°, 270° or 360°, is composed of a certain number of sources (1) spread over a certain number of levels, or crowns as (2), (3), (4), (5) and (6) in a specific fashion. Sources used, for example weak/medium/high power lasers, can be integrated, for example in optical sources modules, in coloured pixel generators, in a certain number of optical matrix heads, for example crown/pyramid type or pavements of mirrors/filters. Collimated or low divergent light beams, as (7) from sources, are angled towards an addressing periscope (8). Through a certain number of mirrors/filters arranged in a specific fashion, for example on an addressing pyramid (8) and/or cone, the addressing periscope sends out beams from sources, for example (1), toward a certain number of mirrors/filters, for example (9), spread over a certain number of optical rotating discs, for example (10) and (11), digitally locked. Mirrors/filters, for example (9) of optical rotating discs have an orientation according to specific angles enabling incident beams reflection, for example (13), passing through a specific mirror/filter window, for example (14), placed on a structure as truncated globe-shaped (15). This mirror/filter window deflects or not the beam according to a specific angle. During a complete rotation, optical rotating discs, for example (10) and (11) introduce incident beams (12) a succession of mirrors/filters combinations imposing a space scanning movement. According to possible configurations, the truncated globe (15) and/or the addressing periscope (8) are rotating or not.

A digital lock of the operating speed of optical rotating discs, for example (10) and (11), and/or the truncated globe (15), completed with a synchronized ignition of sources, enables space scanning, thus projecting a sequence of images composed of a certain number of pixels, onto any surface or into any volume. Through powering this multibeam scanning digital video projection device with a coloured pixel generator and/or an optical matrix head, for example crown/pyramid type and/or pavements of mirrors/filters, it becomes possible to display, for example, a sequence of video frames onto any surface or into any volume, and/or the 2D or 3D recording/digitisation, within a solid angle from 0 to 360°, for example, 180°, 270°, or 360°.

The coupling of a capture function, for example (16), with each source, for example (1), enables recording of the reflected signal by any surface and/or any volume, for example (17), in the area scanned by the optical multibeam scanning digital video projection device. This one is then used in digitiser and/or radar mode which, by sending and receiving in a specific direction of space from a modulated signal, for example an amplitude modulation of a signal with a specific wavelength, enables determination of the distance from this surface, for example (17) through measurement, for example of time-lag or loss of synchronisation, of the signal received, after a round-trip flight, for example (18) and (19), by the sensor. This loss of synchronisation is often called “time of flight” of the wave which, multiplied by its propagation speed, allows to deduce the distance.

Throughout this document, sources modules can be replaced and/or completed by a recording system enabling achievement of a digitiser and/or radar type function onto any surface or into any volume in 2D or 3D. The electromagnetic beams used can be from visible, infrared, ultraviolet, microwave domains, or from any other frequency domain adapted to the environment and/or the measurements to be carried out.

According to possible configurations (FIG. 2), the multibeam scanning video projection and/or digital recording device, is composed of a certain number of optical rotating discs, for example (10), and an addressing periscope, as pyramid-shaped (8) or upturned cone (20). It can be completed by a structure, fixed or rotating, stand of a certain number of specific mirrors/filters windows (14). Depending on the area to scan, this structure may present, for example, a shape of any hoop, of a certain number of arcs, of a half-globe (21), of a truncated globe (22), of a complete globe (24) including, for example two optical rotating discs (10), with an addressing periscope, for example (20), of a cylinder (23), surmounted by a half-globe or not (25).

This mirrors/filters windows stand structure (FIG. 3), for example truncated globe-shaped (15), is composed of a certain number of mirrors/filters windows stand crowns, for example (26), on which are positioned a certain number of mirrors/filters windows, for example (14), in a small cavity, for example (27). These mirrors/filters windows (14) have a certain number of passive or active specifications enabling modification of a certain number of beams physical properties crossing it on a given area, for example a spatial filtering. Mirrors/filters windows (14) will be composed of a treated layers stack, for example (28) and (29), with metallization process, and more or less distant, for example (30), depending on targeted applications. Mirrors/filters windows may have a treatment as wavelength gradient treatment enabling, for example, wavelength selection of the beam crossing it function of the scanning imposed to the beam by the optical rotating discs.

The specific mirrors/filters windows shape is related to the structure supporting them. They may be rectangular, trapezoidal, circular, thus specifying a scanning space or volume, for example cone or pyramid-shaped. According to optical rotating discs constituting the multibeam scanning video projection and/or digital recording device, mirrors/filters windows, for example (14), are scanned (FIG. 4) by a beam generated by a source, for example rectangular-shaped or type (31). The mirror/filter window is scanned, for example fully (32), according to a line (33) or a point (34), depending on the size of the source and/or the specific temporal synchronization period. Then, it is possible, depending on the mirror/filter window specifications, for example (14), and a specific synchronization between optical rotating discs, to select a different filtering characteristic for a same addressing zone. The mirrors/filters windows stand structure, for example truncated globe-shaped (15), enables creation of multiplexing and/or spatial/frequency/temporal filtering functions. All mirrors/filters windows on the structure, if necessary, could be active components as semiconductor type or photodiode allowing to integrate the recording function.

The addressing periscope, for example (FIG. 5), within the multibeam scanning video projection and/or digital recording device, is made, for example, of an addressing cone (20) stand of mirrors/filters allowing to deport a number of sources or sensors, for example (35) and (36), shared out on a number of levels/crowns. Such addressing periscope may be used in order to widen the beams scanning area, for example (37) and (38), above the optical rotating discs, for example (10).

The addressing periscope previously described may be completed (FIG. 6) with another addressing cone (39) towards the first, below optical rotating discs with a central hole. This addressing periscope configuration enables, for example, optimization of the scanning zone imposed by optical rotating discs, for example (37) and (38).

In order to density the number of beams simultaneously scanned by the multibeam scanning video projection and/or digital recording device (FIG. 7), multi-sector optical rotating discs could be used, for example (44), composed of a specific layout of mirrors/filters, for example on the surface (40) or in “steps shaped” (41), with a specific orientation enabling scanning of any surface or any volume in 2D or 3D. According to possible configurations, each sector of the optical rotating disc may be addressed, for example, with an addressing periscope cone (20) incorporating a certain number of mirrors/filters, by a certain number of optical sources modules, for example (35) and (36), and/or optical matrix heads, for example crown/pyramid type (42) and/or pavements of mirrors/filters (43), share out onto a certain number of levels/crowns. Each level addresses a specific sector of the multi-sector optical rotating disc.

Moreover, it is possible (FIG. 8) to share out, according to a specific layout, a certain number of sources on each level/crown to address simultaneously several sectors of a same optical rotating disc, for example (10), through an addressing periscope as cone (20) or pyramid-shaped (8). Using, for example (FIG. 9), a certain number of these levels/crowns enables multi-sector optical rotating disc addressing, for example (44), simultaneously on a certain number of sections shared out on a certain number of sector.

With regard to multi-sector optical rotating disc (44), several configurations of sources and addressing periscopes layouts may be performed (FIG. 10), (FIG. 14), and (FIG. 17) as in line (45), according to an isosceles triangle (46) or right triangle (47) or (48). The optical sources layout enables to carry out a set of a certain number of colinear beams in a reduce size without beams specifications or intrinsic properties alteration. According to the possible realization variants, sources layout (45) could be (FIG. 14) steps shaped (49), in staggered rows (50), V-shaped (51) and (52), or any other geometric layout that performs a set of a certain number of colinear beams evenly spaced. According to possible realization variants, the mirrors/filters of the addressing periscope (FIG. 17) can be carried out, for example, with a certain number of small mirrors/filters (53) on mounts (54), hold down with a mount (55), for example, as stair steps-shaped. This mount, could be assembled on dynamic correction elements as screws, piezoelectric micro-actuators . . . .

According to possible configurations, the deflection device (FIG. 11) of the addressing periscope incorporates a certain number of mirrors/filters stands shared out on a certain number of levels and a base (56), circular for the cone (20), or square for a pyramid (8).

Different optical rotating discs variants (FIG. 12) are possible as (57) and (58), comprising a certain number of optical lanes, for example (59), which enable addressing of an on-board cone-shaped periscope (39) rotating or not, placed on the optical rotating disc axis. The on-board periscope allows addressing of mirrors/filters shared out onto sectors, for example (60) over the surface of optical rotating disc through, for example, another cone-shaped addressing periscope (20). Another optical rotating disc variant consists in positioning, in the extremity of each lane, for example (59), a certain number of mirrors/filters, for example (61), allowing the beam spreading over the lane to reflect onto the mirrors/filters, for example (62), near the surface of the optical rotating disc. Similarly, it is possible to position a certain number of mirrors/filters, for example (61) and (63), reflecting the beam coming from the optical lane in the opposite direction, slightly above, to a mirror/filter (62) inserted into the bulk of the optical rotating disc. An additional filtering function can be obtained using a succession of mirrors/filters, for example (61), (64) and (65) in optical lane extremity, for example a wavelength filtering.

In order to increase the resolution of the multibeam scanning video projection and/or digital recording device, an optical matrix head (FIG. 13) as crown/pyramid-shaped (66) and/or pavements of mirrors/filters (67) may be use. These two optical matrix heads permit generation of a matrix of a certain number of colinear beams through succession of transmissions/reflections on a number of mirrors/filters with a specific layout.

The pyramid, part of the crown/pyramid-shaped optical matrix head (66), and/or the deflection device of the addressing periscope may be an arrangement, for example (67), of a certain number of deflection pyramids (8), and/or deflection cones (20), enabling a densification process of the number of beams issued from the matrix head and/or addressing the optical rotating discs. As alternatives, the deflection pyramids (8), and/or deflection cones (20), are fixed by a shaft, for example (67), (68), (69) fitted out of very fine stems or full and rigid stems not blocking off the light rays from a source.

Several kinds of deflection pyramids and/or cones layouts on the shafts are possible (FIG. 15), for example “Christmas tree” shaped, the pyramids and/or cones are held in place by a support (67) full or composed of very fine stems linked to the base (69).

In these layouts case, one must take into account size constraints and the number of beams getting on pyramid-shaped and/or conic-shaped deflection elements which will be positioned on a same plane, for example in line (70), or shared out in space (71) or (72). Indeed, according to the pyramid and/or cone sizes, and the number of incident beams on the mirrors/filters towards two pyramids and/or cones positioned at the same level, for example (73) and (74), the space between the two elements must afford, with a not so open angle, beams passing (75), (76) for the pyramid or cone (73), (77) and (78) for the pyramid (74). To avoid this problem, pyramids and/or cones can be positioned on different levels and/or shared out evenly. The aim is to obtain a matrix of colinear beams, evenly spaced in output and/or pointed at the optical rotating discs sectors. It is thus possible to obtain (FIG. 15) a 3D architecture (71), where each capital letters represents a pyramid-shaped element. In such configuration, a certain number of pyramids and/or cones, for example C and B pointed, could be on a same level but not showing faces towards each other. A spiral distribution solution (72) also obviates the tendency to have addressing problems.

Sources (35) supplying the addressing periscope, for example (8), are positioned (FIG. 16), for example, on a certain number of levels/crowns (79), allowing to steer the beams toward mirrors/filters (80), positioned in the center of rings on a base (56), which could be pyramidal-shaped, conic-shaped or other, structuring beams in a colinear way and/or to obtain an addressing matrix of a certain number of mirrors/filters shared out onto a certain number of sectors of a certain number of optical rotating discs of the multibeam scanning video projection and/or digital recording device.

It can be useful, for device stability reasons or for static and/or dynamic corrections, to apply under the pyramid and/or the cone of the addressing periscope a trim-corrected base (FIG. 18). This trim-corrected base device, for example of the pyramid (8), is composed of three elements (81), (82), (83) as screw, piezoelectric micro-actuator etc, set, for example, according to an isosceles triangle between a lower platform (84) supporting elements and an upper platform (85) supporting the pyramid (8). A rapid electronic control of these three elements (81), (82), (83) as screw, piezoelectric micro-actuator, imposes a very low trim-correction.

The rotation of the mount structure of a certain number of mirrors/filters windows, and/or optical rotating discs, can be carried out with a rotating stage and lift on air-cushion generated in a hollow ring (87). The stage lift, interdependent of the structure to rotate, is performed through a certain number of openings, for example (88), shared out into a hollow ring (87) according to a specific arrangement which creates a pressurized air zone with an entering air flow correcting leakage, for example (89), commonly known as “air cushion”. The rotational motion is then imposed, for example by another air flow (90) pushing on the fins (91) spread over the edge of the plate (86) and having a specific orientation.

Another embodiment of this rotating and lift stage lies in the fact that an electromagnetic field achieves the rotation and the lift.

The current invention is intended, in a first time, for applications in the field of video projection onto any surface or into any volume and/or the 2D or 3D recording/digitisation. The recording device insertion and use of electromagnetic beams with specific wavelengths, for example, visible, infrared, ultraviolet, microwave optics, permits to extend the field of application to digitiser, radar, telecommunications, road/air/sea/space transport.

1-14. (canceled)

15. A 2D/3D multibeam scanning synchrone video projection and/or digital recording device characterized by:
a radial optical matrix head structure including a pyramidal-shaped or cone-shaped central addressing periscope, the periscope is equipped with mirrors and filters, the aforesaid structure being equipped of lasers sources shared out at the central addressing periscope periphery, where the sources may be declined
a) as optical sources modules, or
b) as radial optical matrix heads with a pyramid of mirrors with lasers sources at the periphery,
c) as pavements of mirrors and filters;
a certain number of light beams, from the optical matrix head, structured as matrix, and pointing to a certain number of optical rotating discs with a certain number of mirrors and filters digitally locked,
the pyramidal or cone-shaped central addressing periscope having a specific arrangement of mirrors and filters so that different beams, from lasers sources and redirected by the central addressing periscope, could be oriented in the three dimensions through the device,
the device allowing the projection of an images sequence by scanning from a series of reflections/transmissions, onto any surface or into any volume, and allowing the 2D or 3D recording/digitisation, within a solid angle from 0° to 360°.

16. A device according to claim 15 characterized by a certain number of incident electromagnetic beams sensors at the periphery, as digitiser.

17. A device according to claim 15 characterized by a certain number of incident electromagnetic beams sensors at the periphery, from an emergent beams reflection of the device onto any surface or into any volume, as radar.

18. A device according to claim 15 characterized by a revolution solid-shaped structure with a certain number of filters windows shared out with specific layout, fixed or in rotation, enabling spatial addressing of any solid angle.

19. A device according to claim 15 characterized by mirrors and/or filters windows provided with a specific passive or active transfer function modifying a certain number of beams physical properties crossing them on a given area, with a specific shape function of the structure, where, according to the spatial addressing zone inside a solid angle from the line or point type scanning function, mirrors and filters including a certain number of superimposed layers, having specific physical characteristics, enable spatial, frequency, temporal filtering and a recording of information through an active element, as semi-conductor or photodiode, these mirrors/filters windows could be polarising filters, index gradient filters, frequency filters or any combination of these last ones.

20. A device according to claim 15 characterized by a pyramidal-shaped addressing periscope where a certain number of structures, pyramidal-shaped, cone-shaped, steps-shaped, positioned or not on a trim-corrected device, enabling deflection or orientation of beams between sources or sensors and mirrors and filters of optical rotating discs, this periscope allowing to shape out a certain number of sources or sensors on a certain number of levels, or rings, positioned above or below optical rotating discs.

21. A device according to claim 15 characterized by a pyramidal-shaped addressing periscope associated with sources arranged at the periphery, allowing the simultaneous addressing of a certain number of mirrors/filters shared out on a number of sectors on a number of optical rotating discs, where these different sectors of an optical rotating disc are on the same level or placed on steps.

22. A device according to claim 15 characterized by a pyramidal-shaped addressing periscope fits out a deflection device of beams, from a certain number of sources, having a number of mirrors/filters fixed over the surface or engraved in the device, pyramidal-shape, cone-shaped, steps shaped, according to an arrangement enabling simultaneous addressing of a certain number of sectors, on a certain number of optical rotating discs with a certain number of levels including optical sources modules having static or dynamic pointing correction, of coloured pixel generators, or optical matrix heads and a static or dynamic trim-corrected device.

23. A device according to claim 15 characterized by a variant of the optical rotating disc with an on-board periscope having a certain number of optical lanes allowing to address a deflection device, a pyramid or a cone, fixed or in rotation arranged on the central axis of the optical rotating disc, with a certain number of sources shared out at the periphery of the optical rotating disc, the optical lanes may have a certain number of mirrors and filters having a specific orientation allowing to address a certain number of other mirrors and/or filters laid over the surface or engraved in the optical rotating disc device.

24. A device according to claim 15 characterized by a certain number of optical sources modules, or a certain number of coloured pixel generators, or a certain number of optical matrix heads, crowns/pyramidal-shaped or pavements of mirrors and filters, or optical matrix heads with a number of deflection pyramids.

25. A device according to claim 15 characterized by a rotating and lift stage on air-cushion used inside a multibeam scanning video projection and/or digital recording device, characterized by the rotation of optical rotating discs or stand structure of filters windows, by means of an air flow which, through a certain number of openings shared out in a specific way at the periphery of the stage, accomplishes the lift and, where another air flow imposes the rotation by means of fins having a specific orientation, shared out at the periphery of the device to set in rotation.

26. A device according to claim 15 characterized by another embodiment of the rotating and lift stage performed by electromagnetic field.
